(19) United States
(12) Patent Application Publication
(10) Pub. No.: US 2023/0062559 A1
(43) Pub. Date: Mar. 2, 2023

(54) HUMIDITY CONTROL MATERIAL FOR FRUITS AND VEGETABLES, STORAGE CONTAINER FOR FRUITS AND VEGETABLES, AND METHODS OF PRESERVING FRUITS AND VEGETABLES

(71) Applicant: SUNACTIS CO., LTD., Osaka (JP)

(72) Inventors: Nobuhiro KANAYAMA, Kobe-shi, Hyogo (JP); Hiroaki KANAYAMA, Suita-shi, Osaka (JP); Junichi AZUMA, Ibaraki-shi, Osaka (JP)

(21) Appl. No.: 17/798,132

(22) PCT Filed: Feb. 8, 2021
(86) PCT No.: PCT/JP2021/004650

§ 371 Date: Aug. 8, 2022

(30) Foreign Application Priority Data
Feb. 8, 2020 (JP) 2020-032348

(51) Int. Cl. B65D 81/24; B65D 81/02; B65D 85/34

(52) U.S. Cl. CPC B65D 81/24; B65D 81/025; B65D 85/34

(57) ABSTRACT

An object of the present invention is to provide a humidity control material for fruits and vegetables, capable of preventing the surface of fruits and vegetables from causing condensation, while preventing the surface of fruits and vegetables from drying. Means for solving the problem is a humidity control material for fruits and vegetables comprising a bag having moisture permeable and waterproof film and water retained inside the bag.

### CROSS-REFERENCE TO RELATED APPLICATION

This application claims benefit under Article 4 of the Paris Convention based on Japanese Patent Application No. 2020-032348 filed in Japan on Feb. 8, 2020, incorporated herein by reference in its entirely.

### TECHNICAL FIELD

The present invention relates to a method of preserving fruits and vegetables, and in particular to a method of maintaining freshness of fruits and vegetables during storage.

### BACKGROUND ART

So-called cold and film packaging storage has been applied as a known technique for suppressing the loss of freshness of fruits and vegetables. MA (Manufactured Atmosphere) packaging materials used for packaging fruits and vegetables have the function of maintaining the freshness of fruits and vegetables inside, by providing, for example, antifogging, moisture retention, strength, transparency, adjustment of the gas composition inside the packaging through barrier against gases, and partial permeability against water vapor. However, the film's moisture permeability is relatively low to prevent fruits and vegetables from drying, and moisture that evaporates from fruits and vegetables easily forms condensation water on the film's inner surface. Then, the condensation water sticks on the surface of fruits and vegetables, resulting in mold and rot. The loss of fruits and vegetables due to the phenomenon of surface wetting is hereinafter referred to as “wetting loss”.

As a result, the period of maintaining freshness of fruits and vegetables is short, the geographical area where they can taste is narrow, and locally produced for local consumption wherein the harvesting and selling areas overlap must be applied. For example, it is difficult to even establish transportation and sales routes to other prefectures.

Patent Document 1 discloses a method of maintaining freshness of fruits and vegetables comprising placing a sheet having moisture absorption and desorption and water absorption functions on at least one of the upper surface and the lower surface of fruits and vegetables and then using a synthetic resin film to wrap the entire fruits and vegetables so that the synthetic resin film does not contact the fruits and vegetables, wherein they are stored at 0° C. to 10° C. The purpose of this method is to suppress the wetting loss of fruits and vegetables harvested at the production site when they are stored or transported in the film, packaging to maintain their freshness.

Patent Document 2 discloses a humidity control sheet comprising a water retaining layer between two outer layers, wherein at least one of the outer layers has moisture permeability and air permeability. The materials used for the outer layer include non-woven fabric, paper and cloth. This humidity control sheet is sealed in a bag together with fresh food.

### PRIOR ART DOCUMENTS

### Patent Documents

Patent Document 1 JP H 10-108618 A
Patent Document 2 JP 2000-5550 A

### SUMMARY OF INVENTION

### Problem to be Solved by Invention

However, in the conventional humidity control sheet, material for the outer layer which retains the water retaining layer has high moisture desorption property, for example, it has moisture permeable and air permeable. In other words, in the conventional humidity control sheet, humidity control is performed by utilizing the moisture absorption and desorption of the water retaining layer. As a result, humidity control accuracy is low, and humidity easily rises around fruits and vegetables, causing the surface of fruits and vegetables to cause over-humidity, resulting in condensation and wetting loss. In addition, the sheet sticks to the surface of fruits and vegetables, causing discoloration and damage on the contact surface between them. The loss of fruits and vegetables caused by such contact is hereinafter referred to as “contact loss”.

The present invention solves the above conventional problems, and an object thereof is to provide a humidity control material for fruits and vegetables and a storage container for fruits and vegetables including the material, the material preventing the surface of fruits and vegetables from causing condensation, while preventing the surface of fruits and vegetables from drying.

### Means for Solving the Problem

The present invention provides a humidity control material for fruits and vegetables, comprising a bag having moisture permeable and waterproof film and water retained inside the bag.

In one embodiment of the invention, an ethylene gas decomposing agent or an ethylene gas absorbing agent is contained in the moisture permeable and waterproof film, or is retained inside the bag.

In one embodiment of the invention, the moisture permeable and waterproof film has a specified moisture permeability, the moisture permeability being such that, when the moisture control material for fruits and vegetables, and fruits and vegetables are placed in a common atmosphere, humidity of the atmosphere is being controlled so that condensation is not substantially caused on the surface of fruits and vegetables.

In one embodiment of the invention, the moisture permeable and waterproof film has such a moisture permeability that a humidity of 56% or more is provided, when water is sealed in the film to be placed in a closed environment at 20° C.

In one embodiment of the invention, the moisture permeable and waterproof film has such a moisture permeability that a humidity of less than 98.6% is provided, when water is sealed in the film to be placed in a closed environment at 20° C.

In one embodiment of the invention, the humidity control material for fruits and vegetables has a water retaining material inside the bag having moisture-permeable and waterproof film.

In one embodiment of the invention, the humidity control material for fruits and vegetables has a sheet-like shape.

In one embodiment of the invention, the humidity control material for fruits and vegetables has transparency.

In one embodiment of the invention, the humidity control material for fruits and vegetables prevents the surface of fruits and vegetables from drying, when the material is placed in an atmosphere common to the fruits and vegetables, by comparison with when the material is not placed in the atmosphere.

In one embodiment of the invention, the humidity control material for fruits and vegetables extends the preservation period of fruits and vegetables, when the material is placed in an atmosphere common to the fruits and vegetables, by comparison with when the material is not placed in the atmosphere.

Also, the present invention provides a storage container for fruits and vegetables comprising any of the above humidity control material for fruits and vegetables.

Also, the present invention provides a method for transporting or preserving fruits and vegetables comprising placing any of the above humidity control material for fruits and vegetables, and fruits and vegetables in a common atmosphere.

In one embodiment of the invention, the present invention provides a humidity control sheet for fruits and vegetables comprising a bag having moisture permeable and waterproof film and water retained inside the bag.

In one embodiment of the invention, the humidity control sheet has a water retaining material inside the bag having moisture permeable and waterproof film.

In one embodiment of the invention, the humidity control film has such a moisture permeability that a humidity of 87% or more is provided, when water is sealed in the film to be placed in a closed environment at 20° C.

In one embodiment of the invention, the humidity control film has such a moisture permeability that a humidity of 89% to 99% is provided, when water is sealed in the film to be placed in a closed environment at 20° C.

In one embodiment of the invention, the fruits and vegetables is selected from the group consisting of strawberries, tomatoes, broccoli, bananas, lemons and Hen-of-the-Woods.

Also, the present invention provides a storage container for fruits and vegetables comprising any of the above humidity control sheet for fruits and vegetables inside.

In one embodiment of the invention, the humidity control sheet for fruits and vegetables is placed at least one side of the upper surface and the lower surface of fruits and vegetables.

In one embodiment of the invention, the storage container for fruits and vegetables has a fruits and vegetables-storing sheet inside, the storage sheet having flexibility, shape retention ability, and a recess to store a body of fruits and vegetables.

In one embodiment of the invention, the storage container for fruits and vegetables has air permeability.

Also, the present invention provides a method of preserving fruits and vegetables comprising storing fruits and vegetables in any of the above storage container for fruits and vegetables.

In one embodiment of the invention, preservation temperature is from 2° C. to 20° C.

In one embodiment of the invention, preservation humidity is 65% or more.

### Effect of the Invention

A humidity control material for fruits and vegetables of the present invention prevents the surface of fruits and vegetables from suffering damage due to condensation or contact, while preventing the surface of fruits and vegetables from drying. Therefore, the method of preserving fruits and vegetables of the present invention does not cause the wetting loss and the contact loss of fruits and vegetables, and extends their preservation period. The preservation period is, herein, referred to as the period during which fruits and vegetables to be stored remain fresh and worth tasting.

### BRIEF DESCRIPTION OF DRAWINGS

FIG. 1 shows a cross-sectional view of an example configuration of a humidity control sheet for fruits and vegetables of one embodiment of the present invention.

FIG. 2 shows a cross-sectional view of another example of a humidity control sheet for fruits and vegetables of one embodiment of the present invention.

FIG. 3 shows a partial cross-sectional view of a storage container for fruits and vegetables of one embodiment of the present invention, in which fruits and vegetables are stored.

FIG. 3(a) shows the humidity control sheet for fruits and vegetables placed on the top surface of fruits and vegetables, and FIG. 3(b) shows the humidity control sheet for fruits and vegetables placed on the lower surface of fruits and vegetables.

FIG. 4(a) shows a photograph of strawberries after 15 days storage of the method of the present invention.

FIG. 4(b) shows a photograph of strawberries after 29 days storage of the method of the present invention.

FIG. 4(c) shows a photograph of strawberries after 40 days storage of the method of the present invention.

FIG. 5 shows a photograph of strawberries stored of the method of the present invention.

FIG. 6(a) shows a photograph of strawberries after one week storage at 20° C. environment of the method of the present invention.

FIG. 6(b) shows a photograph of strawberries after one week storage at 3° C. environment of the method of the present invention.

FIG. 6(c) shows a photograph of strawberries after one week storage at 20° C. environment without a humidity control sheet of the method of the present invention.

FIG. 7(a) shows a photograph of the appearance of banana before storage test.

FIG. 7(b) shows a photograph of the appearance of banana after one week storage at 15° C.

FIG. 7(c) shows a photograph cf bananas stored in a bag-shaped container including a humidity control sheet of the present invention.

FIG. 7d shows a photograph of the appearance of bananas stored in a bag-shaped container for one week at 15° C.

### DESCRIPTION OF EMBODIMENTS

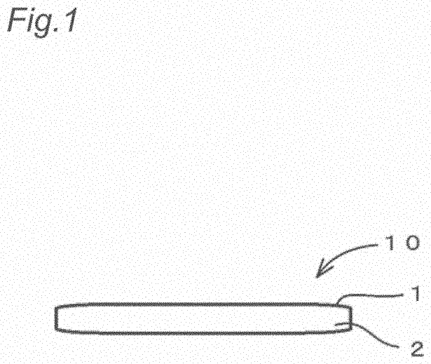

The present invention provides a humidity control material for fruits and vegetables including a bag having moisture permeable and waterproof film and water retained inside the bag. The term “retain” means that the object is kept in a specified location or condition. FIG. 1 shows a cross-sectional view of an example configuration of a humidity control sheet for fruits and vegetables of one embodiment of the present invention. The humidity control sheet for fruits and vegetables 10 includes a bag having moisture permeable waterproof film 1 and water 2 retained inside the bag.

The moisture permeable and waterproof film may contain an ethylene gas decomposing agent or ethylene gas absorbing agent. The ethylene gas decomposing agent or ethylene gas absorbing agent may be retained inside the bag having moisture permeable and waterproof film. Removal of ethylene gas from the atmosphere surrounding the humidity control material for fruits and vegetables enhances the effect of inhibiting the loss of freshness of fruits and vegetables when they are stored or transported.

Specific examples of ethylene gas decomposition agents that may be used in the present invention are listed below.
(1) Chemically reactive ethylene decomposition agent in which potassium permanganate, as an oxidant, is supported on silica or zeolite (e.g., Ethylene Control 0173 (trade name), manufactured by San-ai Corporation and e-FRESH (trade name), manufactured by MORIYA Sangyo Co., Ltd.);
(2) Chemisorption-type ethylene absorbent/remover in which bromine is adsorbed to activated carbon (e.g., Crisper (trade name), manufactured by OhE Chemical Inc.);
(3) Photocatalytic decomposers using TiO2 or WO3, solid oxide catalytic decomposers in which palladium, nickel, or platinum particles are supported, decomposers using mesoporous cobalt oxide or silica-supported metal catalysts, and zeolite-supported silver ion catalysts;
(4) Antifogging film containing zinc oxide powder deposited by a few amount of organosilica compound, made of 97.0% or more of zinc oxide and 1.00 to 1.20% of organosilicone compound (e.g., ME-FRESH (trade name) film, see Table 1, manufactured by Kobayashi Co.); and
(5) Antifogging film containing special ceramics (e.g., Shokusen Fresh Sheet (trade name), manufactured by M.A.T. Co. )

Specific examples of ethylene gas adsorbents that may be used in the present invention are listed below.
1) Activated carbon (commercially available activated carbon, but has limitation in adsorption capacity); and
(2) Those utilizing antifogging film containing Oyaishi (e.g., Aisaika (trade name), see Table 1, manufactured by Nipro Co.).

Fruits and vegetables is, generally, referred to as fresh vegetables and fruits. Examples of fruits and vegetables include fruit-like vegetables such as melons, watermelons, and gourds; fruit vegetables such as eggplants, tomatoes, and cucumbers; flower vegetables such as broccolis, cauliflowers, and Japanese gingers; root vegetables such as wild yams, gingers, and wasabi; leafy greens such as asparagus, celery, and lettuce; berries such as strawberries, blueberries, blackberries, raspberries, cranberries, cherry peaches, and buffalo berry; common fruits such as bananas, apples, persimmons, mangoes, papayas, grapes, figs, loquats, Nashi pears, European pears, kiwifruits, peaches, plums, prunes, and chocolate vine; citrus fruits such as ponkan, Citrus unshiu, Citrus natsudaidai, Citrus hassaku, navel, grapefruits, lemons and oranges; mushrooms such as Hen-of-the-Woods and Jew's Ear Fungus; and others.

Fruits and vegetables are preferably fruit-like vegetables such as strawberries; fruit vegetables such as tomatoes; flowering vegetables such as broccolis; common fruits such as bananas, grapes and European pears; citrus fruits such as lemons; mushrooms such as Hen-of-the-Woods; root vegetables such as Japanese yams.

Fruits and vegetables may be young corns, corns, snap peas, okra, potherb mustard and Mitsuba, etc.

A moisture permeable and waterproof film means a resin film that has the property of blocking liquids such as water, but allowing gases such as water vapor to pass through. A bag having moisture permeable and waterproof film 1 may be at least partially made of the moisture permeable and waterproof film. The bag having moisture permeable and waterproof film 1 need be sealed to prevent water inside from leaking out. The bag having moisture permeable and waterproof film 1 may be joined or sealed by binding, gluing, or heat-sealing its edges or openings.

By using the humidity control sheet for fruits and vegetables mentioned above, the phenomenon of condensation on the surface of fruits and vegetables is suppressed when they are stored. The humidity control sheet for fruits and vegetables may be placed on one or both sides of the upper surface or lower surface of fruits or vegetables when they are stored. The entire fruits or vegetables may be wrapped in the humidity control sheet for fruits and vegetables. In this case, the humidity control sheet for fruits and vegetables may contact the surface of fruits and vegetables. Even in such a case, the phenomenon of water condensation on the surface of fruits and vegetables during storage is suppressed.

In one preferred embodiment, a storage container for fruits and vegetables may be produced by using the humidity control sheet for fruits and vegetables mentioned above. One example of such container is a bag-shaped container having a structure wherein two square-shaped humidity control sheets for fruits and vegetables are layered and their three sides are joined. One of the two layered humidity control sheets for fruits and vegetables which form the bag-shaped container, may be a sheet-shaped material different from the humidity control sheet for fruits and vegetables. A sheet-shaped or plate-shaped material different from humidity control sheet for fruits and vegetables may be partially bonded to the humidity control sheet for fruits and vegetables to form the bag-shaped container. A bag-shaped container having at least partially a humidity control sheet for fruits and vegetables may store multiple fruits and vegetables together, provide the convenience of transportation and storage, and provide uniform and reliable humidity control for the stored fruits and vegetables.

The humidity control material for fruits and vegetables of the present invention allows the bi-directional transfer of moisture through the contact the surface of fruits and vegetables. Therefore, even, during the contact, humidity may be controlled, drying of fruits and vegetables due to moisture dispersal is prevented and the tautness and shine of fruits and vegetables is maintained.

The moisture permeable and waterproof film has a specified moisture permeability. When the moisture permeability of the moisture permeable and waterproof film is high, the amount water vapor released by the humidity control material for fruits and vegetables becomes large, and humidity of the surrounding atmosphere increases. When the moisture permeability of the moisture permeable and waterproof film is law, the amount of water vapor released by the humidity control material for fruits and vegetables becomes small, and humidity of the ambient atmosphere decreases.

When fruits and vegetables are stored or transported, fruits and vegetables and the humidity control material for fruits and vegetables are stored in a space separated from the outside atmosphere, such as a container. In such a situation, humidity of the atmosphere in the space is in equilibrium at a constant value of less than 100%. When humidity of the atmosphere in the space is above 100%, the surface of fruits and vegetables will be over-humidified, and condensation and wetting losses are caused, which is undesirable.

Humidity of the ambient atmosphere of the humidity control material for fruits and vegetables, i.e. humidity at equilibrium, is mainly determined by the following factors. That is, 1) the moisture permeability of the moisture permeable and waterproof film, 2) the sealing condition of the atmosphere surrounding the humidity control material for fruits and vegetables, 3) temperature of that atmosphere, and 4) the moisture desorption property of fruits and vegetables.

The high moisture permeability of the moisture permeable and waterproof film, the high sealing condition of the atmosphere, the high temperature of the atmosphere or the high desorption property of the fruits and vegetables are factors that results high values of humidity in the atmosphere surrounding the humidity control material for fruits and vegetables. The low moisture permeability of the moisture permeable and waterproof film, the low sealing condition of the atmosphere, the low temperature of the atmosphere or the low moisture desorption property of the fruits and vegetables are factors that result in low values of humidity in the atmosphere surrounding the humidity control material.

The moisture permeability of the moisture permeable and waterproof film is such a moisture permeability that, when a humidity control material for fruits and vegetables, and fruits and vegetables are placed in a common atmosphere, humidity of the atmosphere is being controlled so that condensation is not substantially caused on the surface of fruits and vegetables. In other words, the moisture permeability of the moisture permeable and waterproof film is such a moisture permeability that humidity of the atmosphere reaches the equilibrium at such a level that condensation is not substantially caused on the surface of fruits and vegetables.

Such the moisture permeability of the moisture permeable and waterproof film suppresses the occurrence of the wetting loss when fruits and vegetables are stored or transported. “Placing a humidity control material for fruits and vegetables, and fruits and vegetables in a common atmosphere” means a condition of that the atmosphere in contact with the humidity control material for fruits and vegetables is also in contact with fruits and vegetables.

The moisture permeability of the moisture permeable and waterproof film is such a moisture permeability that, when the humidity control material for fruits and vegetables, and fruits and vegetables are placed in a common atmosphere, humidity of the atmosphere is controlled so that the surface of fruits and vegetables is prevented from drying. In other words, the moisture permeability of the moisture permeable and waterproof film is such a moisture permeability that humidity of the atmosphere reaches the equilibrium at such a level that the surface of fruits and vegetables is prevented from drying. Such the moisture permeability of the moisture permeable and waterproof film suppresses the loss of the freshness of fruits during storage or transport so that the preservation period of fruits and vegetables is extended.
1) The moisture permeability of the moisture permeable and waterproof film may be appropriately determined in view of
2) sealing condition of the ambient atmosphere around the humidity control material for fruits and vegetables, 3) temperature of the atmosphere, and 4) moisture desorption property of fruits and vegetables, when fruits and vegetables are stored or transported.

In view of controlling humidity of the ambient atmosphere around fruits and vegetables to an appropriate range, the moisture permeable and waterproof film has such a moisture permeability that, for example, a humidity of 62% to 98.6%, preferably 67% to 96.4%, more preferably 73% to 96%, even more preferably 75% to 94% is provided, when water is sealed in the film to be placed in a closed environment at room temperature. In this specification, the wording “humidity” means relative humidity (% RH).

The space, in which fruits and vegetables and humidity control material for fruits and vegetables are stored when storing or transporting fruits and vegetables, preferably has a certain degree of air permeability. In such condition, the moisture permeable and waterproof film has such a moisture permeability that a humidity of at least 87%, preferably 89% to 99%, more preferably 90% to 96%, even more preferably 91% to 94% is provided, when water is sealed in the film to be placed in a closed environment at room temperature, in view of controlling humidity in the atmosphere around the fruits and vegetables to an appropriate range.

On the other hand, the space, in which fruits and vegetables and fruits and vegetables humidity control materials are stored may have limited air permeability. For example, when storing or transporting fruits and vegetables, there may be a case, in which they are wrapped externally in cardboard boxes, paper boxes, plastic containers or Styrofoam boxes with poor air permeability. In spaces with limited air permeability, the atmosphere around a humidity control material for fruits and vegetables easily cause over-humidity and lead to condensation.

In such condition, the moisture permeable and waterproof film has such a moisture permeability that a humidity of 62% to 87%, preferably 67% to 82%, more preferably 73% to 81%, and even more preferably 75% to 78% is provided, when water is sealed in the film to be placed in a closed environment at room temperature, in view of controlling humidity in the atmosphere around the fruits and vegetables to an appropriate range.

The moisture permeability of a moisture permeable and waterproof film here is measured by the following operations. That is, three-sides of the moisture permeable and waterproof film is sealed to form a bag, water is placed in the bag, and the opening is sealed. This bag with sealing water is placed in a glass desiccator, a thermo-hygrometer is installed therein, and the desiccator is covered with a lid. The desiccator is left for 3-7 days until humidity in the desiccator is constant. The constant humidity (equilibrium saturated humidity) is measured with the thermo-hygrometer. Temperature in the desiccator is maintained at room temperature (i.e. 20±0.5° C.).

The thermo-hygrometer may be, for example, the Weathercom II EX-502 (trade name) manufactured by Empex Instruments, Inc. Water sealed in the bag made of the moisture permeable and waterproof film may, optionally, contain water-retaining materials such as water-absorbing polymers. The measured humidity is the equilibrium saturated humidity. The value suffers no affect even when water is retained in the water-retaining material inside the bag made of the moisture permeable and waterproof film.

Materials for moisture permeable and waterproof film include, but are not limited to, moisture-proof cellophane coated film, polyethylene, polypropylene and nylon as specific examples. The moisture permeable and waterproof film preferably has a flexibility which does not cause the contact loss when, the film contacts fruits and vegetables. In such a view, the thickness of the moisture permeable and waterproof film is less than 70 μm, preferably from 1 to 30 μm, more preferably 3 to 15 μm.

Specific examples of moisture permeable and waterproof film which may be used in the present invention are shown in Table 1. In Table 1, the external relative humidity (%) refers to the moisture permeability as used herein.

At an external relative humidity of 98.6%, condensation was observed on the inner walls of the desiccators.

TABLE 1

| | external | | | | |
|---|---|---|---|---|---|
| | relative | | | resistant | |
| | humidity | | thickness | temperature | |
| name of film | (% RH) | main material | (μm) | (° C.) | manufacturer |
| Pichitto | 98.6 | polyvinyl alcohol | 10 | — | Okamoto Co. |
| NatureFlex ™ 23NVS | 98.6 | moisuture• | 23.3 | Heat sealable | Futamura Chemical Co. |
| | | proof coat cellophane | | | |
| Xtend ® Grapes (885-GR45/L) | 96.4 | Nylon•polyethylene | 10 | Heat sealable | StePac LA Ltd |
| | | composite | | | |
| I-wrap | 94 | polyethylene | about 7 | −30 | Iwatani marerials Co. |
| Pico 230, 220 | | | | | |
| Keepod | 94 | polyethylene | 36~37 | −30 | KDS creative products Co. |
| Plastic bag for food strage | 94 | high density polyethylene | 10 | −30~110 | Nihon sanipak Co. |
| Keep Fresh | 93 | polyethylene | 9 | −30 | Strixdesign Co. |
| Freshness preserving plastic bag | | | | | |
| BOX Plastic bag Humming pack | 91 | polyethylene | 8 | −30 | Nikko Co. |
| Freshness preserving bag | 91 | polyethylene | 10 | −30 | SHOEI Corporation Co. |
| I-wrap UF | 91 | polyethylene | 9 | −30~120 | Iwatani marerials Co. |
| Miracle Fresh | 91 | polyethylene | 20 | −30 | Axciatec Co. |
| Porofresh PORO-FF5 25 μm | 90 | polypropylene | 25 | — | Futamura Chemical Co. |
| POROSO Processed composite film | 90 | polyethylene terephthalate• | 40 | — | Touhoujushi chemical Co. |
| | | sealant•polyethylene | | | |
| | | composite laminate | | | |
| Kitchen pack | 88 | polyethylene | about 10 | −30 | Ube resin film Co. |
| P-plus Yasashi Ecobag | 88 | nylon•polyethylene | 40 | −50 | Sumitomo Bakelite Co. |
| | | (2 layers) | | | |
| Fukuro de sendo wo tamoto-san | 87 | polyethylene | 9 | −30 | Kobayashi Co. |
| Porofresh PORO-FF5 30 μm | 82 | polypropylene | 30 | — | Futamura Chemical Co. |
| Kabinai bag | 81 | polyethylene•polypropylene | 80 | −40 | Top dou Co. |
| Antibacterial freshness-preserving film | 78 | polypropylene | 30 | — | SEKISUI material solustions Co. |
| ME-FRESH | 78 | polyethylene | 20 | −30 | Kobayashi Co. |
| Vegofresh | 77 | polyethylene•polypropylene | 45 | −10 | Horix Co. |
| Orapack | 75 | polypropylene | 20~40 | −30 | Bellegreenwise Co. |
| Spash film | 75 | polypropylene | 25 | — | Mitsui Chemicals Tohcello Inc. |
| Aisaike | 74 | polyethylene | 50 | −30 | Nipro Co. |
| Nylonpoly TL type | 73 | nylon•L-LDPE25•L-LDPE30 | 70 | −30~96 | Fukusuke indusrial Co. |
| Redkeeper | 67 | polyethylene | 27~28 | — | Okamoto Co. |
| Functional film SLE-K | 63 | polyethylene terephthalate• | 50 | — | Koei Co. |
| | | polyethylene | | | |
| Tanakakun Hajimeteno Banans | 62 | polypropylene•polyethylene | 50 | — | Tanaka banana Co. |

The amount of water retained inside the bag having moisture permeable and waterproof film is appropriately determined, taking into account the weight of the fruits and vegetables and their preservation period. The water in the bag may, optionally, contain antioxidant, antibiotics, antibacterial, bactericidal or ageing inhibitors, such as vitamin C, chitosan, cypress or horseradish extract ingredients, titanium dioxide, and allyl isothiocyanates, sulpha drugs.

When the amount of water inside the bag having moisture permeable and waterproof film is large, the shape of the humidity control material for fruits and vegetables will be soft and mat-like, and when the amount of water is small, the shape of the humidity control material for fruits and vegetables will be sheet-like.

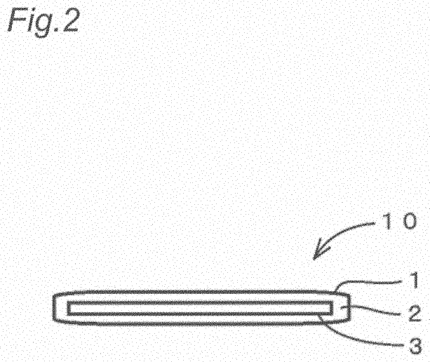

FIG. 2 shows a cross-sectional view of another example of a humidity control sheet for fruits and vegetables of the present invention. A humidity control sheet for fruits and vegetables 10 has water 2 and a water retaining material 3 inside a bag having moisture permeable and waterproof film 1.

The water retaining material is used, optionally, for the purpose of stabilizing the shape of the humidity control sheet for fruits and vegetables and preventing water splashing in case that the bag having moisture permeable and waterproof film is broken. The water retaining material may be water retaining and sheet-shaped material such as non-woven fabrics, paper, cloth and absorbent polymer films, or water retaining and shapeless material such as pulp, cotton, textiles and absorbent polymers. The water retaining and sheet-shaped material and water retaining and amorphous material may be used in combination.

It is preferred that the water retaining material has transparency in the water retaining state so that condition of the fruits and vegetables is able to be checked from the outside. The water retaining material is preferably lightweight in order to reduce the cost and labor of transport.

Transparency means that the presence of fruits and vegetables can be visually recognized when they are covered with a humidity control sheet for fruits and vegetables. In view of improving the transparency of the humidity control sheet for fruits and vegetables, preferably, the sheet does not have any water retaining material inside the bag having moisture permeable and waterproof film.

Bemliese (manufactured by Asahi KASEI Co.) is one example as a sheet material with excellent lightweight and transparency in the water containing state. Bemliese is a non-woven fabric made of cellulose, which may be used for a wide variety of fruits and vegetables due to its multiple properties caused of its thickness. The use of the material meets the Sustainable Development Goals (SDGs).

Preferred water absorbent polymers are those available as food additives. As specific examples of water absorbent polymers, polysaccharide derivatives such as carboxy methyl cellulose, acrylic acid polymer partially cross-linked with sodium salt, methyl cellulose; microbial polysaccharides (e.g. gellan gum), tuber polysaccharides (e.g. konjac glucomannan), seed polysaccharides (e.g. tamarind seed gum) and seaweed polysaccharides (e.g. carrageenan, alginate, etc.) may be used.

The storage container for fruits and vegetables is used for the purpose of distinguishing the atmosphere wherein fruits and vegetables are stored from the atmosphere of the external environment. The form of the storage container for fruits and vegetables is not limited as long as it has adequate strength and handling ease for containing and storing fruits and vegetables, and may be box-shaped and stand-alone type, a flexible bag, or a combination of both.

The storage container for fruits and vegetables needs to have air permeability so as not to inhibit fruits and vegetables from breathing. The storage container for fruits and vegetables preferably has a vent to prevent that humidity of the internal atmosphere becomes too high to cause condensation.

The material of the storage container for fruits and vegetables is not limited, but it needs transparency and resistance to being retained and transported. For example, any of oriented polypropylene, cast polypropylene, polylactic acid, low density polyethylene, linear low density polyethylene, medium density polyethylene, high density polyethylene, vinyl chloride, nylon-based resins and polyester-based resins may be used. Copolymers of, for example, polyethylene with vinyl acetate, acrylic or polyvinyl alcohol or blends of them may also be used. Copolymers of polypropylene and alpha olefins may also be used. The use of polylactic acid meets the SDGs.

The storage container for fruits and vegetables of the present invention has the humidity control sheet for fruits and vegetables of the present invention inside. In one preferred embodiment, the storage container for fruits and vegetables has a fruits and vegetables-storing sheet having flexibility and shape retention ability. The storage sheet has a recess to hold a body of the fruits and vegetables. Such container allows to provide humidity to each of fruits and vegetables stored in more uniform manner. In addition, such container suppresses the damage of fruits and vegetables, for example, caused by contacting with each other due to vibrations and shaking during transport.

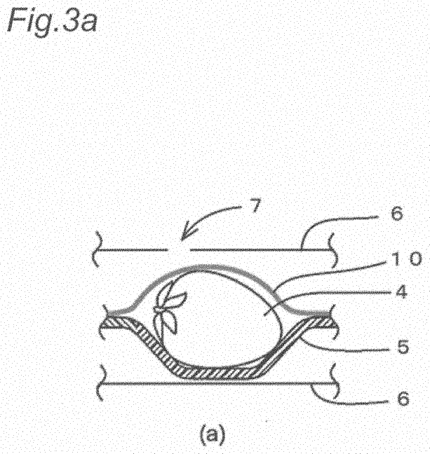

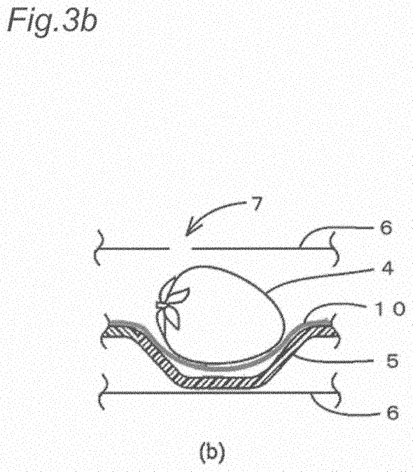

FIG. 3 shows a partial cross-sectional view of a storage container for fruits and vegetables, in which fruits and vegetables are stored of the present invention. The storage container for fruits and vegetables 6 has a vent 7 in the upper wall and has a humidity control sheet for fruits and vegetables 10 and a fruits and vegetables-storing sheet 5 inside. The storage sheet for fruits and vegetables 5 stores fruits and vegetables 4 inside.

The material of the fruits and vegetables-storing sheet may be, for example, a foamed synthetic resin sheet with flexibility and shape retention. Examples of foamed synthetic resins include foamed polystyrene, foamed polyethylene and foamed polypropylene and so on. Soft paper similar to fresh egg storage packs may also be used as the material for this fruits storage sheet.

Among foamed synthetic resin sheets, a foamed polystyrene sheet is preferred because it is well-suited for the surface of fruits and is less likely to cause the pressed surface, the damage due to rubbing, localized over-humidity, discolouration and dripping. For example, a type of foamed polystyrene sheet (product name “styrene paper”) manufactured by JSP Corporation, which has high softness and a beautiful surface, has particularly well-contact with fruits and vegetables. When strawberries are stored using this type of sheet, for example, it is possible to store them without damaging their surface.

In the humidity control sheet for fruits and vegetables of the present invention, the moisture permeable and waterproof film has flexibility and the water retained inside has cushioning properties. Therefore, the humidity control sheet for fruits and vegetables of the present invention may also be used as a fruits and vegetables-storing sheet. For example, a storage sheet for fruits and vegetables may be laid on the bottom of a storage container for fruits and vegetables and the fruits and vegetables may be stored on it.

A bag having moisture permeable and waterproof film may be partitioned into multiple chambers inside. A bag having moisture permeable and waterproof film may be partitioned into multiple chambers, for example, by bonding its upper film and its lower film in a linear or grid pattern. For the purpose of lightweight and so on, some of the multiple chambers may retain water. The amount of water to be retained in each chamber may also be regulated. In such cases, it is preferable to place the fruits and vegetables in the chambers of the storage sheet for fruits and vegetables which retain water.

FIG. 3(a) shows a humidity control sheet for fruits and vegetables 10 placed on the top surface of fruits and vegetables 4. The storage sheet for fruits and vegetables 10 contacts the upper surface of fruits and vegetables 4 and covers them due to its flexibility, and deforms according to their shape due to own weight of the sheet. FIG. 3(b) shows a humidity control sheet for fruits and vegetables 10 placed on the lower surface of fruits and vegetables 4. The humidity control sheet for fruits and vegetables 10 may be placed on the upper and lower surfaces of fruits and vegetables 4.

Storage temperature for fruits and vegetables may vary depending on the type of fruits, but generally is 2° C. to 20° C., preferably 3° C. to 10° C., more preferably 3° C. to 6° C. When the storage temperature is lower than 2° C., low-temperature damage is likely to occur. When the storage temperature is 10° C. or higher, the higher the temperature, the shorter the preservation period may be. The storage temperature is preferably maintained at substantially constant value throughout the preservation period.

Fruits and vegetables are generally stored at humidity which is at least 65%, preferably 87% to 96%, more preferably 90% to 91%, but, in view of the temperature-humidity-dew point relationship, berries such as strawberries are stored at humidity being 70% to 96%, preferably 72% to 94%, more preferably 77% to 90% under 3° C. When storage humidity is below 65% in general, and below 70% for berries such as strawberries, the surface of the fruits and vegetables easily dry and their shelf life is likely to be shorten, while when humidity is above 96%, any fruits and vegetables easily causes partial condensation on the surface of fruits and vegetables, resulting in the wetting loss. Storage humidity is preferably maintained at a substantially constant value throughout the preservation period.

### EXAMPLES

The following examples will further illustrate the present invention in detail, but the present invention is not limited to these examples.

### Example 1

A bag made of polyethylene film (“I-wrap UF” (trade name) manufactured by Iwatani material Co.) with a thickness of approximately 10 μm was prepared as a bag having moisture permeable and waterproof film. The moisture permeability of this polyethylene film was measured using the method described above and was 91% relative humidity.

The bag made of polyethylene film described above was used to produce a storage sheet for fruits and vegetables as follows. That is, a cellulose fiber nonwoven fabric with a thickness of 0.38 mm (“Bemliese SE 803” (trade name) manufactured by Asahi KASEI CO.) was prepared and cut to dimensions of 21 cm (length)×17 cm (width) and inserted inside the above bag. Furthermore, 20 g of water was placed inside the bag and the opening was sealed by heat-sealing to manufacture a humidity control sheet for lying under fruits and vegetables.

Next, a cellulose fiber nonwoven fabric with a thickness of 0.17 mm “Bemliese SJ 18J” (trade name) manufactured by Asahi KASEI CO.) was prepared, cut to dimensions of 23 cm (length)×19 cm (width) and inserted inside the above bag. Furthermore, 15 g of water was placed inside the bag and the opening was sealed by heat-sealing to produce a humidity control sheet for overlay fruits and vegetables.

Strawberries (‘Marihime’ (trade name) from Wakayama Prefecture) were prepared as fruits and vegetables to be stored. A storage container for fruits and vegetables with a vent on its upper wall was prepared, which includes a fruits and vegetables-storing sheet having flexibility and shape retention vegetables and having a recess that accommodates strawberries. The storage container for fruits and vegetables was opened and a humidity control sheet for the underlay was laid over the storage sheet for fruits and vegetables according to the condition shown in FIG. 3(b). Next, the strawberries were stored on top of the humidity control sheet for underlay, the humidity control sheet for overlay was placed on the top surface of the strawberries according to the condition shown in FIG. 3(a), and the container was closed.

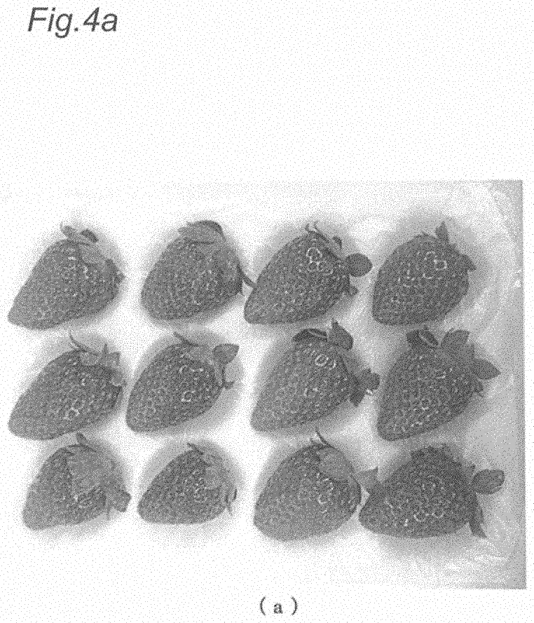

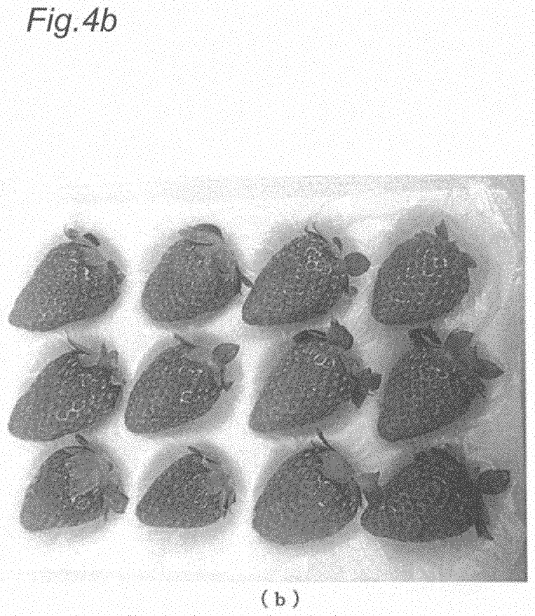

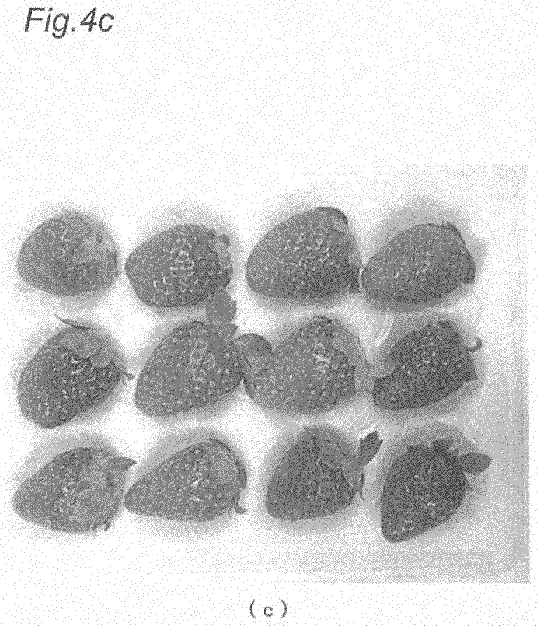

Storage container for fruits and vegetables storing strawberries were placed in a refrigerator regulated at temperature of 3° C. and humidity of 90-91%. After a predetermined period of time, the storage container for fruits and vegetables were taken out from the refrigerator and their storage conditions were checked. The appearance of the fruits after storage is shown in FIG. 4. (a) shows the appearance after 15 days storage, (b) shows the appearance after 29 days storage and (c) shows the appearance after 40 days after storage. No condensation was observed on the surface of the strawberries during any of the preservation period. The taste of the fruits after storage was also evaluated to ensure that the freshness worth tasting was remained.

When no humidity control sheets were placed in the storage container for fruits and vegetables, deterioration due to mold spread throughout the storage containers after one week of storage.

### Example 2

A humidity control sheet for underlay and a humidity control sheet for overlay are produced in a similar manner of Example 1, except that “Keepod” (trade name) manufactured by KDS creative products Co. is used instead of Iwatani material's “I-wrap UF” (trade name). These sheets were placed in the storage container for fruits and vegetables and strawberries were stored in the storage container for fruits and vegetables in a similar manner of Example 1.

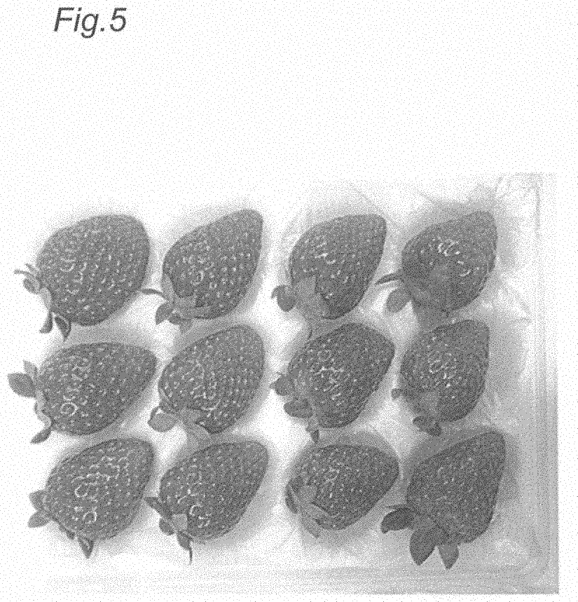

Storage container for fruits and vegetables storing strawberries were placed for 3 weeks in a refrigerator regulated at temperature of 3° C. and humidity of 90% to 91%. The appearance of the strawberries after storage is shown in FIG. 5. No condensation was observed on the surface of the strawberries after storage. The taste of the fruits after storage was also evaluated to ensure that the freshness worth tasting was remained.

When no humidity control sheets were placed in the storage container for fruits and vegetables, deterioration due to mold spread throughout the storage containers after one week of storage.

### Example 3

The effect of storage temperature was verified. A humidity control sheet for underlay and a humidity control sheet for overlay are produced in a similar manner of Example 1 except that “I-wrap Pico 230” (trade name) is used instead of “I-wrap UF” (trade name) manufactured by Iwatani material Co. These sheets were placed in the storage container for fruits and vegetables and strawberries (“Yumenoka strawberries” (trade name) from Saga Prefecture) were stored in the storage container for fruits and vegetables in a similar manner of Example 1.

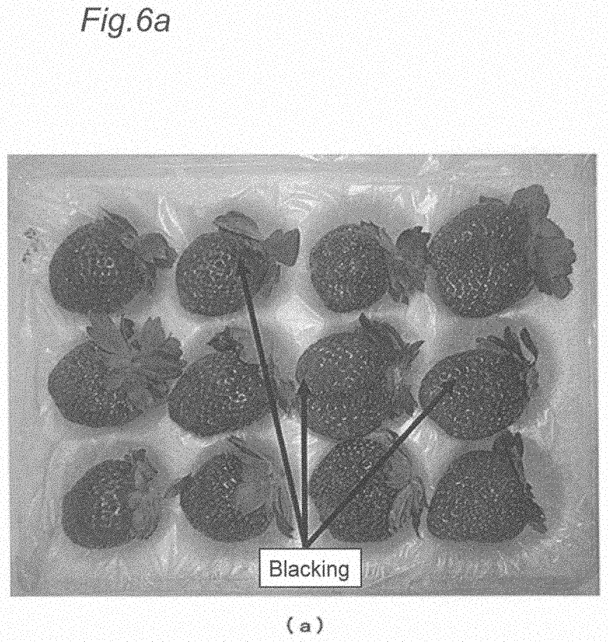

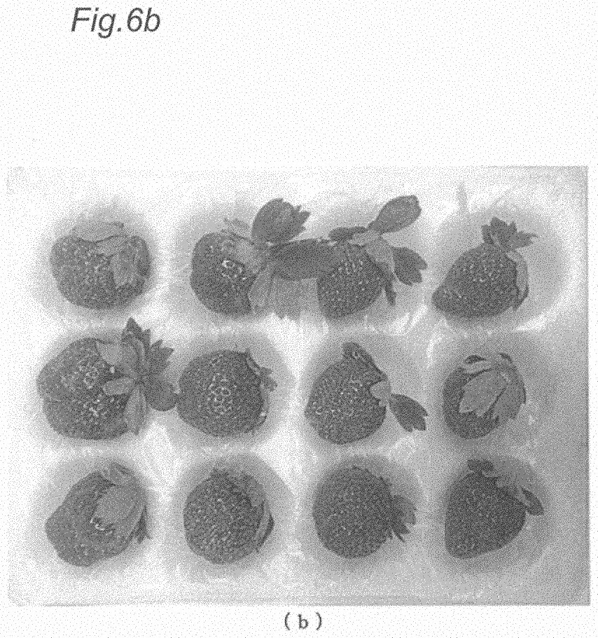

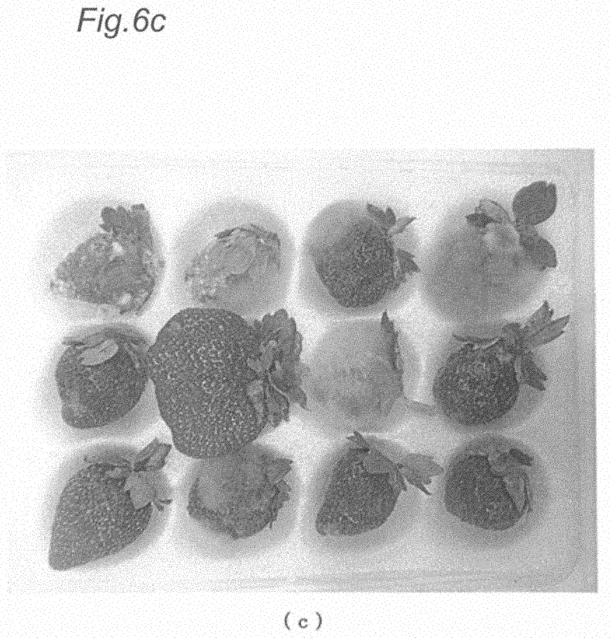

Storage container for fruits and vegetables containing strawberries were stored for 1 week at temperature of 20° C. and 3° C. The appearance of the strawberries after storage is shown in FIG. 6. (a) shows the appearance at 20° C. environment, (b) shows the appearance at 3° C. environment and (c) shows the appearance at 20° C. environment without a humidity control sheet. For strawberries stored at 20° C., blackened areas were observed on some strawberries, but no mold was observed. For strawberries stored at 3° C., no condensation formed on the surface of them and their freshness was maintained.

When storage container for fruits and vegetables were stored at 20° C. without humidity control sheet, deterioration due to mold spread throughout the storage container within one week.

### Example 4

3.5 g to 20 g of water -absorbing polymer gel was placed in a bag of polyethylene film (“I-wrap UF” (trade name), manufactured by Iwatani materials Co.) with a thickness of about 10 μm as a bag with moisture permeable and waterproof film and its opening was sealed by heat-sealing to produce a humidity control sheet.

The humidity control sheet was spread flat and the fruits and vegetables to be stored were placed on it and wrapped entirely. The fruits and vegetables wrapped in the humidity control sheet were placed in a refrigerator regulated at temperature of 3° C. and humidity of 90% to 91%. After a predetermined period of time, the fruits and vegetables were removed from the refrigerator. The weight and firmness of the fruits and vegetables were measured before and after storage. Weight and firmness measurements of three to five samples were carried out and the average of them was taken as the measured value.

The weight of fruits and vegetables relates to their freshness, and when they are left in the conditions as harvested, they dry rapidly, resulting in weight loss. Once they dried, it is difficult to restore their freshness by being absorbed moisture. The smaller the range of weight loss, the more preferable, as it is also related to yield.

The firmness of fruits and vegetables relates to their freshness and may soften with ripening (e.g. bananas, Citrus unshiu and Citrus hassaku) or harden with drying (e.g. young corns, okra and asparagus). The smaller the range of change in hardness, the more preferable.

The firmness of fruits and vegetables was measured using “Food Rheology Tester FRT-50N” (trade name) manufactured by IMADA Co. wherein a rod plunger with the diameter of 3 mm (Φ3) was installed and load was applied to the surfaces of fruits and vegetables under the compression mode at displacement speed 0.2 mm/s, the load being as compression load.

The types of fruits and vegetables tested and the test results are shown in Tables 2 and 3. For the purpose of avoiding low-temperature damage, the storage temperature was set at 10° C. for cucumbers in Table 2 and 8° C. for Citrus unshiu and Citrus hassaku in Table 3. The storage temperature was set at 15° C. for bananas.

TABLE 2

| fruits | type of | weight (g) | | | weight loss (%) | | firmness (N) | | |
|---|---|---|---|---|---|---|---|---|---|
| and | the humidity | | after | after | after | after | | after | after |
| vegetables | control sheet | row | 1 week | 3 weeks | 1 week | 3 weeks | row | 1 week | 3 weeks |
| Young corn | present | 85.65 | 81.41 | 81.08 | 4.95 | 5.33 | 13.87 | 13.04 | 13.11 |
| | absent | 83.55 | 62.49 | 54.41 | 25.21 | 34.88 | 14.97 | 11.65 | 12.77 |
| Fig | present | 107.16 | 104.89 | 102.45 | 2.12 | 4.40 | 0.31 | 0.39 | 0.32 |
| | absent | 96.61 | 63.43 | 60.94 | 25.58 | 36.92 | 0.38 | 0.53 | 0.99 |
| Snap pea | present | 33.02 | 30.02 | 26.80 | 9.10 | 18.84 | 9.02 | 7.65 | 6.78 |
| | absent | 36.74 | 17.04 | 12.81 | 53.60 | 65.12 | 8.88 | 6.24 | 5.35 |
| Okra | present | 62.91 | 57.14 | 48.54 | 9.17 | 22.8 | 8.91 | 7.53 | 8.32 |
| | absent | 49.90 | 36.72 | 18.80 | 26.41 | 62.3 | 8.79 | 10.16 | 12.18 |
| Asparagus | present | 74.06 | 70.32 | 69.47 | 5.05 | 6.2 | 14.24 | 16.05 | 17.35 |
| | absent | 73.16 | 61.29 | 55.39 | 16.23 | 24.3 | 14.65 | 12.49 | 17.25 |
| Potherb mustard | present | 108.35 | 107.16 | 108.09 | 1.10 | 0.2 | — | — | — |
| | absent | 79.45 | 54.82 | 29.15 | 31.00 | 63.3 | — | — | — |
| Mitsuba | present | 24.74 | 23.81 | 22.89 | 3.77 | 7.5 | — | — | — |
| | absent | 28.34 | 20.23 | 11.32 | 28.62 | 60.1 | — | — | — |
| Cucumber | present | 127.04 | 124.00 | 118.08 | 2.39 | 7.1 | 13.19 | 15.44 | 16.71 |
| (10° C.) | absent | 132.63 | 128.42 | 121.26 | 3.18 | 8.6 | 15.39 | 17.83 | 17.51 |

TABLE 3

| fruits | type of | weight (g) | | | weight loss (%) | | firmness (N) | | |
|---|---|---|---|---|---|---|---|---|---|
| and | the humidity | | after | after | after | after | | after | after |
| vegetables | control sheet | row | 1 week | 3 weeks | 1 week | 3 weeks | row | 1 week | 3 weeks |
| Kiwifruit | present | 110.52 | 109.74 | 108.92 | 0.70 | 1.45 | 7.20 | 7.92 | 7.09 |
| | absent | 115.68 | 115.28 | 114.50 | 0.58 | 1.02 | 7.03 | 7.44 | 9.13 |
| Cherry | present | 4.00 | 3.70 | 3.41 | 7.50 | 14.75 | 2.17 | 2.19 | 2.19 |
| (Sato nishiki) | absent | 3.59 | 3.09 | 2.74 | 13.93 | 23.68 | 2.01 | 1.96 | 1.86 |
| Cherry | present | 9.03 | 8.76 | 8.08 | 2.99 | 10.52 | 2.26 | 2.19 | — |
| (Benisyuhou) | absent | 9.41 | 7.80 | 6.14 | 17.11 | 34.75 | 2.16 | 1.86 | — |
| Grape | present | 246.57 | 241.89 | 233.72 | 1.90 | 5.21 | 3.39 | 3.99 | 4.06 |
| (King Delaware) | absent | 263.09 | 258.76 | 240.59 | 1.65 | 8.55 | 3.20 | 4.21 | 3.88 |
| Grape | present | 622.30 | 604.40 | 562.10 | 2.87 | 9.68 | 6.48 | 6.13 | 5.28 |
| (Shine Muscat) | absent | 621.30 | 596.60 | 418.50 | 3.86 | 32.64 | 6.02 | 5.37 | 4.96 |
| Grape | present | 496.10 | 491.00 | 464.40 | 1.02 | 6.38 | 6.32 | 6.05 | 4.64 |
| (Pione) | absent | 482.20 | 468.46 | 385.78 | 2.85 | 20.00 | 5.96 | 5.37 | 4.64 |
| Japenes Loquat | present | 44.74 | 44.57 | 44.41 | 0.37 | 0.72 | 3.16 | 4.02 | 4.92 |
| | absent | 47.89 | 47.11 | 45.51 | 1.63 | 4.97 | 3.68 | 4.57 | 7.32 |
| Tomato | present | 144.33 | 143.91 | 143.31 | 0.29 | 0.71 | 4.24 | 4.58 | 4.43 |
| (Momotaro) | absent | 120.30 | 118.75 | 116.59 | 1.29 | 3.08 | 4.44 | 3.93 | 3.96 |
| Cherry tomato | present | 11.07 | 10.89 | 10.77 | 1.64 | 2.68 | 6.27 | 7.12 | 6.42 |
| | absent | 11.16 | 10.80 | 10.36 | 2.49 | 6.40 | 6.37 | 6.18 | 5.54 |
| Melon | present | 797.60 | 795.80 | 793.70 | 0.23 | 0.49 | 33.36 | 33.53 | 34.17 |
| (Andean melon) | absent | 731.10 | 726.60 | 718.00 | 0.62 | 1.79 | 33.21 | 37.97 | 41.17 |
| Citrus onshiu | present | 271.28 | 252.33 | 245.54 | 6.98 | 9.5 | 20.13 | 17.34 | 14.28 |
| (Nichiran 8° C.) | absent | 256.72 | 224.64 | 196.91 | 12.50 | 23.3 | 19.93 | 14.56 | 9.12 |
| Citrus hassaku | present | 251.15 | 246.74 | 232.27 | 1.76 | 7.5 | 30.15 | 28.90 | 28.17 |
| (8° C.) | absent | 264.62 | 246.40 | 217.08 | 6.13 | 18.0 | 28.89 | 18.33 | 13.11 |

### Example 5

3.5 g to 20 g of water-absorbing polymer gel was placed in a bag of polyethylene film (“I-wrap UF” (trade name), manufactured by Iwatani materials Co.) with a thickness of about 10 μm as a bag with moisture permeable and waterproof film and its opening was sealed by heat-sealing to produce a humidity control sheet.

A bag made of polyethylene film (“ME-FRESH” (trade name), manufactured by Kobayashi Co.) with a thickness of about 20 μm containing an ethylene gas decomposition agent were prepared as a bag with moisture permeable and waterproof film. Ethylene gas decomposers contain at least 97.0% zinc oxide and 1.00% to 1.20% organosilicon compounds. The moisture permeability of this polyethylene film was measured using the method described above and was 78% relative humidity. 3.5 g to 20 g of water absorbent polymer gel was placed inside the above polyethylene film bag and its opening was heat-sealed to produce humidity control sheet 2 made of ethylene gas-degrading film.

The humidity control sheet 3 was prepared by heat-sealing the opening of a polyethylene film bag (“l-wrap UF” (trade name), manufactured by Iwatani material Co.) wherein 3.5 g to 2.0 g of water-absorbing polymer gel and one 10 g ethylene gas absorbent (“Crisper H F10” (trade name), manufactured by OhE Chemical Inc.) were placed, the polyethylene film bag having approximately 10 μm thickness and being used as a bag with moisture permeable and waterproof film.

Two of the prepared humidity control sheets were layered and joined by heat-sealing their three edges to produce a bag-shaped container made of humidity control sheets. The fruits and vegetables to be stored were stored in a bag-shaped container made of humidity control sheets, with the openings fastened with opening or lightly bound the sheets so that air permeability is maintained. Fruits and vegetables stored in a bag-shaped container were placed inside a refrigerator regulated at temperature of 3° C. and humidity of 90% to 91%. After a predetermined period of time, the fruits and vegetables were removed from the refrigerator. Weight and firmness were measured before and after storage. Weight and hardness measurements were made on three to five samples and the average of these was taken as the measured value. In addition, if the fruits and vegetables are moved daily for checking and photographing inside, a piece of dry cushioning material (6.5×16.0×0.4 cm) made of cotton was placed in the bottom.

The types of fruits and vegetables tested and the test results are shown in Table 4.

TABLE 4

| fruits | type of | weight (g) | | | weight loss (%) | | firmness (N) | | | |
|---|---|---|---|---|---|---|---|---|---|---|
| and | the humidity | | after | after | after | after | | after | after | |
| vegetables | control sheet | row | 1 week | 3 weeks | 1 week | 3 weeks | row | 1 week | 3 weeks | remarks |
| Banana | Normal | 381.84 | 377.05 | 374.96 | 1.26 | 1.80 | 7.14 | 6.57 | 5.89 | Sugar spot appears and blackening |
| (15° C.) | sheet 1 | | | | | | | | | progresses daily |
| | Ethylene gas | 441.68 | 440.88 | 436.34 | 0.18 | 1.21 | 10.66 | 9.32 | 6.04 | Sugar spot appears and blackening is |
| | decomposition | | | | | | | | | delay |
| | film sheet 2 | | | | | | | | | |
| | Sheet | 480.73 | 475.30 | 465.07 | 1.13 | 3.07 | 9.95 | 8.87 | 7.91 | Sugar spot appears and blackening is |
| | including | | | | | | | | | delay |
| | ethylene gas | | | | | | | | | |
| | absorbent 3 | | | | | | | | | |
| | None | 463.70 | 458.80 | 427.00 | 1.06 | 7.91 | 11.12 | 7.89 | 6.61 | Sugar spot appears and blackening |
| | | | | | | | | | | progresses rapidly |
| Broccoli | Normal | 365.21 | 360.91 | 354.97 | 1.18 | 2.80 | 46.53 | 38.39 | 35.17 | Flower bud formation progresses, being |
| | sheet 1 | | | | | | | | | yellowing and corolla collapses |
| | Ethylene gas | 326.63 | 321.70 | 315.50 | 1.51 | 1.93 | 35.79 | 35.11 | 33.04 | Flower bud formation and rotting are |
| | decomposition | | | | | | | | | suppressed without yellowing |
| | film sheet 2 | | | | | | | | | |
| | Sheet | 480.73 | 475.30 | 465.97 | 1.13 | 1.96 | 39.36 | 38.14 | 37.75 | Flower bud formation and rotting are |
| | including | | | | | | | | | suppressed witihout yellowing |
| | ethylene gas | | | | | | | | | |
| | absorbent 3 | | | | | | | | | |
| | None | 370.62 | 280.09 | 232.25 | 24.43 | 37.33 | 47.10 | 36.63 | 26.15 | Yellowing and drying due to progress of |
| | | | | | | | | | | flower bud formation |
| Cauliflower | Normal | 526.60 | 523.70 | 505.31 | 0.55 | 4.04 | 32.54 | 28.06 | 27.01 | Flower bud formation and yellowing |
| | sheet 1 | | | | | | | | | progress |
| | Ethylene gas | 528.70 | 524.30 | 515.12 | 0.83 | 1.75 | 27.06 | 28.63 | 33.04 | Flower bud formation and rotting are |
| | decomposition | | | | | | | | | suppressed without yellowing |
| | film sheet 2 | | | | | | | | | |
| | Sheet | 471.40 | 414.30 | 404.80 | 12.11 | 2.29 | 28.66 | 28.32 | 28.02 | Flower bud formation and rotting are |
| | including | | | | | | | | | suppressed without yellowing |
| | ethylene gas | | | | | | | | | |
| | absorbent 3 | | | | | | | | | |
| | None | 528.80 | 459.50 | 406.32 | 13.11 | 23.16 | 30.20 | 24.14 | 19.99 | Yellowing and partial rotting and drying |
| | | | | | | | | | | progress |

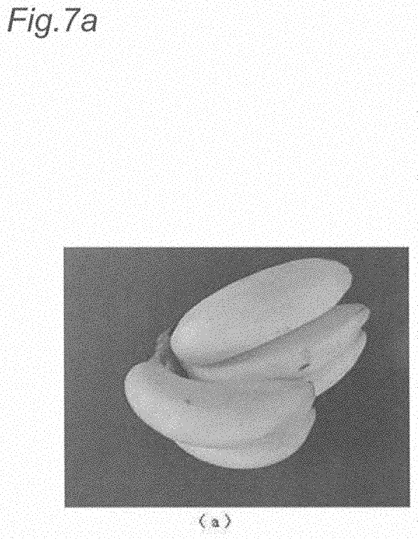

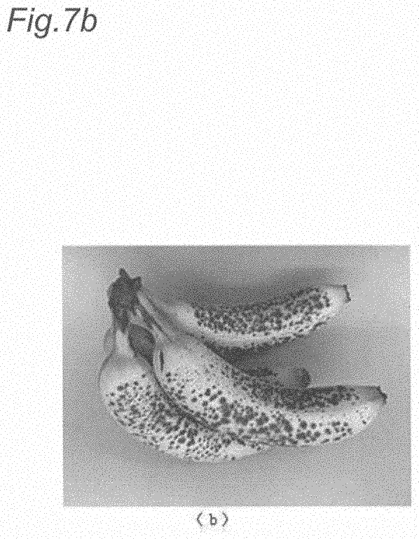

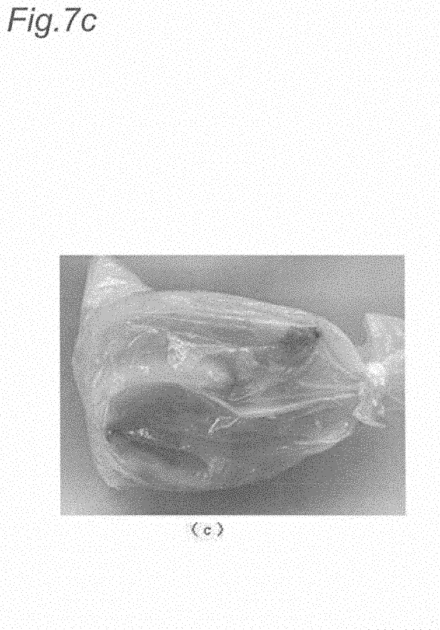

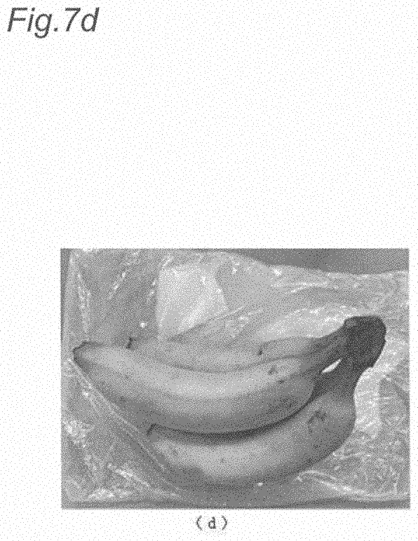

Referring to FIG. 7, the results obtained in the test in Example 5, in which bananas are stored in a refrigerator at 15° C. and 90% to 91% humidity for one week are explained. FIG. 7a shows a photograph of the appearance of a banana before storage. Sugar spots or blackening, which indicate loss of freshness, do not appear on the appearance of these bananas. FIG. 7b shows a photograph of the appearance of bananas to which the humidity control sheet was not applied during storage. The appearance of the bananas shows a clear and large amount of sugar spotting, especially at the ends, with blackening.

FIG. 7c shows a photograph of bananas before storage in a bag-shaped container made of humidity control sheet 2. The opening of the bag-shaped container is tied to prevent the contents from spilling out, but a gap is left open and air permeability is maintained. FIG. 7d shows a photograph of the appearance of bananas stored in a bag-shaped container. No clear sugar spots appear on the appearance of these bananas and the amount of blackening is low. In other words, it is understood that the freshness of bananas stored in bagged containers with the humidity control sheet s of the present invention was maintained during storage.

### DESCRIPTION OF NUMERALS

1 . . . bag having moisture permeable and waterproof film
2 . . . water
3 . . . water retaining material
4 . . . fruits and vegetables
5 . . . fruits and vegetables-storing sheet
6 . . . storage container for fruits and vegetables
10 . . . humidity control sheet for fruits and vegetables

1. A humidity control material for fruits and vegetables, comprising
a bag having moisture permeable and waterproof film; and
water retained inside the bag.

2. The humidity control material for fruits and vegetables according to claim 1, wherein an ethylene gas decomposing agent or an ethylene gas absorbing agent is contained in the moisture permeable and waterproof film, or is retained inside the bag.

3. The humidity control material for fruits and vegetables according to claim 1, wherein
the moisture permeable and waterproof film has a specified moisture permeability,
the moisture permeability being such that, when the moisture control material for fruits and vegetables, and fruits and vegetables are placed in a common atmosphere, humidity of the atmosphere is being controlled so that condensation is not substantially caused on the surface of fruits and vegetables.

4. The humidity control material for fruits and vegetables according to claim 1, wherein the moisture permeable and waterproof film has such a moisture permeability that a humidity of 62% or more is provided, on condition that water is sealed in the film to be placed in a closed environment at 20° C.

5. The humidity control material for fruits and vegetables according to claim 1, wherein the moisture permeable and waterproof film has such a moisture permeability that a humidity of less than 98.6% is provided, on condition that water is sealed in the film to be placed in a closed environment at 20° C.

6. The humidity control material for fruits and vegetables according to claim 1, having a water retaining material inside the bag having moisture-permeable and waterproof film.

7. The humidity control material for fruits and vegetables according to claim 1 having a sheet-like shape.

8. The humidity control material for fruits and vegetables according to claim 1 having transparency.

9. The humidity control material for fruits and vegetables according to claim 1, the material being able to prevent the surface of fruits and vegetables from drying more, on condition that the material is placed in an atmosphere common to the fruits and vegetables, than the condition that the material is not placed in the atmosphere.

10. The humidity control material for fruits and vegetables according to claim 1, the material is able to extend the preservation period of fruits and vegetables more, on condition that the material is placed in an atmosphere common to the fruits and vegetables, than the condition that the material is not placed in the atmosphere.

11. A storage container for fruits and vegetables, comprising the humidity control material for fruits and vegetables according to claim 1.

12. A method for transporting or preserving fruits and vegetables, comprising placing the humidity control material for fruits and vegetables according to claim 1, and fruits and vegetables in a common atmosphere.

13. The method of transporting or preserving fruits and vegetables according to claim 12, wherein the storage temperature is between 2° C. to 20° C.

14. The method of transporting or preserving fruits and vegetables according to claim 12, wherein the storage humidity is 65% or more.

15. The humidity control material for fruits and vegetables according to claim 1, wherein the moisture permeable and waterproof film has such a moisture permeability that a humidity of 62% or more and less than 98.6% is provided, on condition that water is sealed in the film to be placed in a closed environment at 20° C.

16. The humidity control material for fruits and vegetables according to claim 1, wherein the moisture permeable and waterproof film has such a moisture permeability that a humidity of 87% or more is provided, on condition that water is sealed in the film to be placed in a closed environment at 20° C.

17. The humidity control material for fruits and vegetables according to claim 1, wherein the moisture permeable and waterproof film has such a moisture permeability that a humidity of 62% to 87% is provided, on condition that water is sealed in the film to be placed in a closed environment at 20° C.

18. A storage container for fruits and vegetables according to claim 11 having air permeability.

19. A storage container for fruits and vegetables according to claim 11 having a fruits and vegetables-storing sheet inside, the storage sheet having flexibility, shape retention ability, and a recess to store a body of fruits and vegetables.

20. The method of transporting or preserving fruits and vegetables comprising storing fruits and vegetables in the storage container according to claim 11.
